(19) United States
(12) Patent Application Publication
(10) Pub. No.: US 2018/0102697 A1
(43) Pub. Date: Apr. 12, 2018

(54) METHOD FOR PRODUCING A WINDING AROUND A PROJECTING POLE FOR A SYNCHRONOUS MOTOR

(71) Applicant: SIEMENS AKTIENGESELLSCHAFT, München (DE)

(72) Inventor: Horst Kümmlee, Berlin (DE)

(73) Assignee: SIEMENS AKTIENGESELLSCHAFT, München (DE)

(21) Appl. No.: 15/565,014

(22) PCT Filed: Jan. 12, 2016
(86) PCT No.: PCT/EP2016/050431

§ 371 Date: Oct. 6, 2017

(30) Foreign Application Priority Data
Apr. 10, 2015 (EP) 15163237.9

(51) Int. Cl. H02K 15/095; H02K 19/26; H02K 3/28; H02K 3/18

(52) U.S. Cl. CPC H02K 15/095; H02K 3/18; H02K 3/28; H02K 19/26

(57) ABSTRACT

In a method for producing a rotor for a synchronous machine suitable for a rotational speed of more than 1000 r.p.m, a plurality of electrically conductive rectangular sub-conductors are loosely joined in parallel to one another lengthwise to form a conductor. The conductor is wound so as to form a winding and thereby form an exciter coil. Directly after winding, the sub-conductors of the conductor are continuously soldered together while the sub-conductors are positioned and/or held together by a forming facility, so that the exciter coil is solid and the conductor rigid.

The invention relates to a method for producing a rotor for a synchronous machine, which is suitable for a rotational speed of more than 1000 r.p.m, having at least one exciter coil, wherein the at least one exciter coil has in each case at least two windings, which consist of a number of parallel electrically conductively connected rectangular sub-conductors.

The invention further relates to a rotor for a synchronous machine, which can be produced with a method of this type.

Furthermore, the invention relates to a synchronous machine which has at least one rotor of this type.

Electric rotating machines are embodied for instance as synchronous machines, in particular as three-phase synchronous machines. Three-phase synchronous machines of this type can be described for instance as a motor or also as a generator. Electric machines, in particular those which are designed as high-rev drives with a rotational speed of more than 1000 r.p.m and with a greater output, for instance more than one megawatt, have to fulfill high requirements in terms of electromagnetic and mechanical properties.

With synchronous machines, the rotor may have permanent magnets or electromagnets. If permanent magnets are used particularly on the outer periphery of the rotor, this is referred to as a permanently excited synchronous machine, wherein a restricted mechanical strength results from the use of permanent magnets. On account of the very strong centrifugal forces occurring then, a high rotational speed may result in a separation or deformation of the surface permanent magnets. If an electromagnet is used with a rotor, this is referred to as an externally excited synchronous machine. Particularly with high outputs, a conductor of the electromagnet must have the necessary bending load capacity for the emerging centrifugal force loads.

The European patent EP 1 287 601 B1 discloses a winding for a stator or rotor of an electric machine with an iron body with slots, which is built at least partially from L-shaped molded parts. Here a limb of an L-shaped molded part in each case forms a slot bar located in a slot and the other limb forms a connecting conductor located at a front side of the stator or rotor.

U.S. Pat. No. 4,617,725 A discloses a method for producing a winding for large salient-pole machines.

The French patent application FR 2 299 754 A1 discloses a superconducting exciter winding for the rotor of a turbo generator.

The object underlying the invention is to provide a method for producing a rotor of the type cited in the introduction, which, compared with the prior art, is cost-effective to produce and which can also be used safely with high rotational speeds and the high centrifugal force loads associated therewith.

This object is achieved by a method for producing a rotor for a synchronous machine, which is suitable for a rotational speed of more than 1000 r.p.m, having at least one exciter coil, wherein the at least one exciter coil in each case has at least two windings, which consist of a number of parallel electrically conductively connected rectangular sub-conductors, wherein the exciter coil is produced with a continuous winding and soldering method such that the number of parallel rectangular sub-conductors are firstly joined together lengthwise loosely to form an entire conductor, whereupon the entire conductor is wound to form an exciter coil and directly after the winding the sub-conductors of the entire conductor are continuously soldered together to form a solid exciter coil with a rigid entire conductor.

Furthermore the object is achieved by a rotor for a synchronous machine, which is suitable for a rotational speed of more than 1000 r.p.m, which can be produced with a method of this type, having at least one exciter coil, wherein the exciter coil has a number of lengthwise electrically conductively connected rectangular sub-conductors and wherein each sub-conductor is embodied in one piece.

Furthermore, the object is achieved by a synchronous machine, which is suitable for a rotational speed of more than 1000 r.p.m and has at least one such rotor.

On account of a continuous winding and soldering method of this type of the parallel rectangular sub-conductors forming a rigid entire conductor, no customized molded parts of the coil sides, which must otherwise be joined together with an expensive positioning and soldering method, are required, which saves on costs in terms of production. The soldered connection of parallel strands embodied in one piece to form a rigid entire conductor ensures a shear-resistant connection and on account of the increased stability permits the use of the rotor with high outputs and large rotational speeds and the high centrifugal force loads associated therewith. The joining-together of rectangular sub-conductors to form an entire conductor further permits the manufacture of different conductor geometries. The supply and discharge lines of the coil ends can be integrated using the same process without using additional connecting parts.

The winding of the loosely joined together sub-conductors preferably takes place with at least one winding spindle. As a result, the desired coil geometry can be produced particularly easily.

In a preferred embodiment the sub-conductors are soldered together with a soft solder method. Since the mechanical loads between the parallel rectangular sub-conductors are not very high, a soft solder method is sufficient to hold these together to form a rigid entire conductor. Cleaning work is minimized in this way. With corresponding devices, a complete pole shoe can be produced with all windings in a continuous manufacturing process.

With a further advantageous embodiment, the sub-conductors are positioned and/or held together during the continuous solder process by a forming facility. This ensures that the sub-conductors remain precisely positioned and soldered precisely in the desired form, provided the tin-lead solder has not yet cooled down. The forming facility correspondingly increases the accuracy of the manufacture.

An insulation is preferably inserted between the at least two windings, which has a high-voltage resistant electrically insulating plastic, in particular aramid, and which is suitable for insulating at least two windings against one another. This is particularly advantageous since in this way a compact, high-voltage resistant and low-loss coil can be realized.

In a preferred embodiment, the parallel rectangular sub-conductors are produced from standard semi-finished products, in particular from copper. These standard semi-finished products can be rectangular wires for instance. This is advantageous since it is thus possible to dispense with customized molded parts which results in a cost-saving.

A cooling tab is molded from one part of the sub-conductor particularly advantageously on at least one outer sub-conductor. This increases the surface of the conductor which has an advantageous effect on the cooling of the current-carrying exciter coil. A lower temperature results in lower losses in the exciter coil, since the specific resistance of copper increases with the temperature. Compared with a previous solution, in which the exciter coil was alternately wound with two copper conductors of different widths, a coil winding and a normal winding, the effort involved in the technical realization is considerably less, thereby producing a cost saving.

The cooling tab is preferably formed with a crimping tool. The molding of cooling tabs preferably arranged locally at regular intervals with a suitable crimping tool can be reproduced particularly easily, cost-effectively and well.

With a further advantageous embodiment, at least one part of a pole shoe and at least one part of a laminated core of the rotor are produced from one piece and the exciter coil is wound directly around the laminated core with the pole shoe. The laminated core with the pole shoe, which are produced from one piece, can consist here of a number of sheets stacked in the axial direction. The exciter coil is wound directly around the laminated core with the integrated pole shoe. Accordingly it is not necessary to fasten the pole shoe mechanically to the laminated core, for instance with screws. This results in an improved stability, particularly with high rotational speeds, since the pole shoe with the screws is exposed to high centrifugal forces particularly with high rotational speeds.

In a preferred embodiment, the windings of the exciter coil have a rounded radius shape at the corners. As a result, notch stresses in the corners are avoided.

The invention is described and explained in more detail below on the basis of exemplary embodiments shown in the figures,

It is shown in:

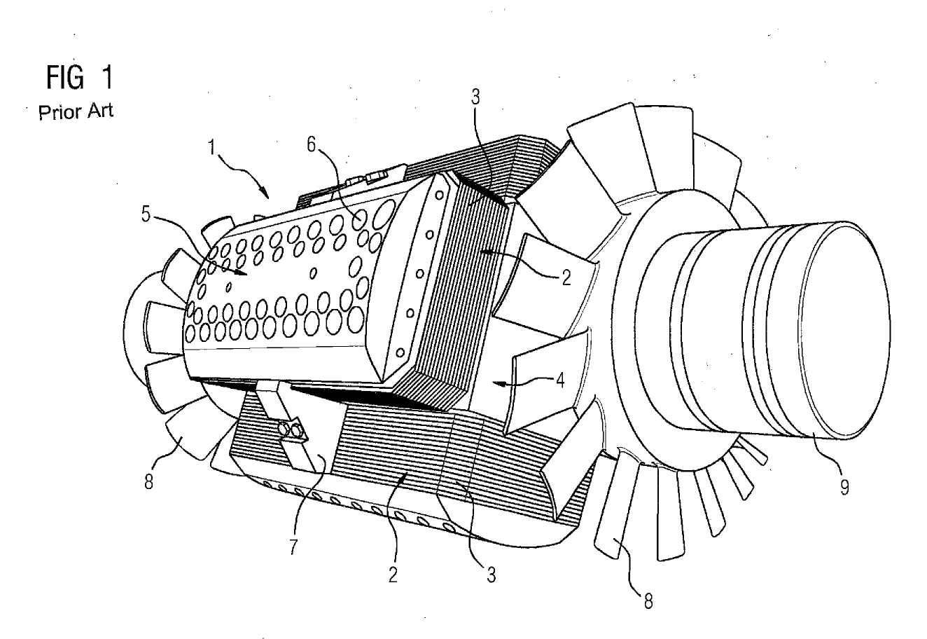

FIG. 1 a three-dimensional view of a rotor of a synchronous machine according to the prior art,

FIG. 2 a three-dimensional view of an exciter coil according to the prior art,

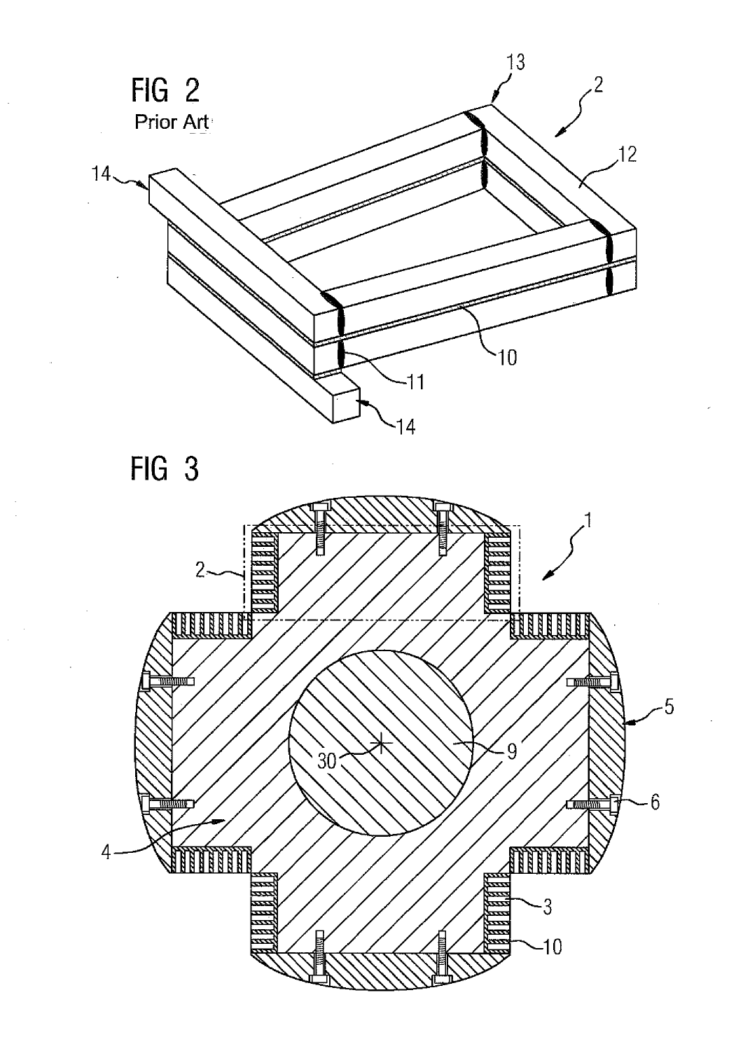

FIG. 3 a cross-section of a rotor of a synchronous machine,

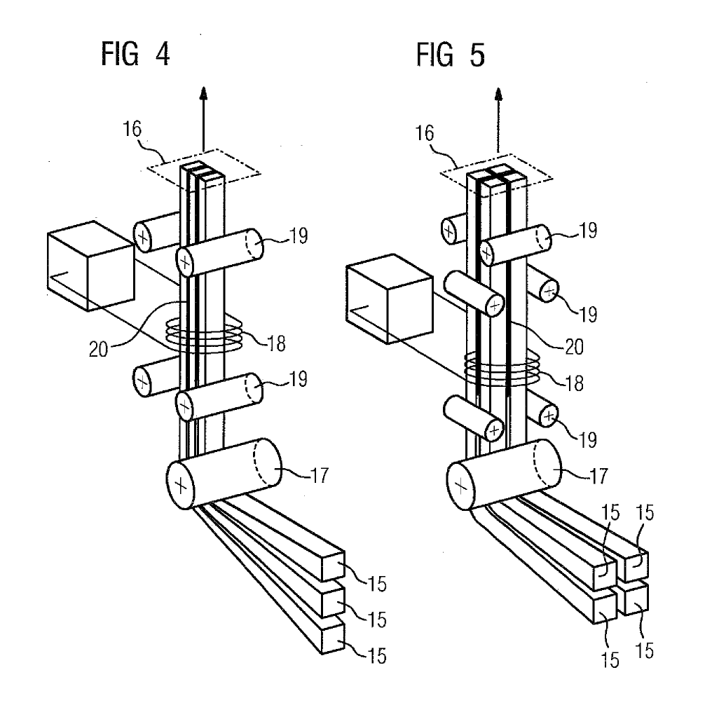

FIG. 4 a three-dimensional view of a continuous winding and soldering method of an exciter coil with 1×3 sub-conductors,

FIG. 5 a three-dimensional view of a continuous winding and soldering method of an exciter coil with 2×2 sub-conductors,

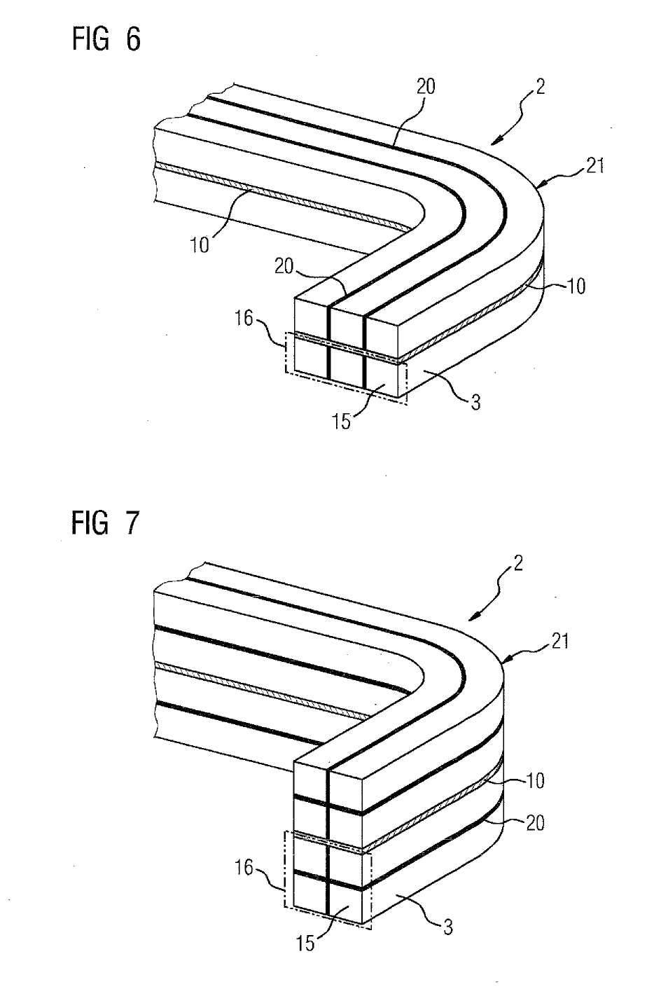

FIG. 6 a three-dimensional view of part of an exciter coil with 1×3 sub-conductors,

FIG. 7 a three-dimensional view of part of an exciter coil with 2×2 sub-conductors,

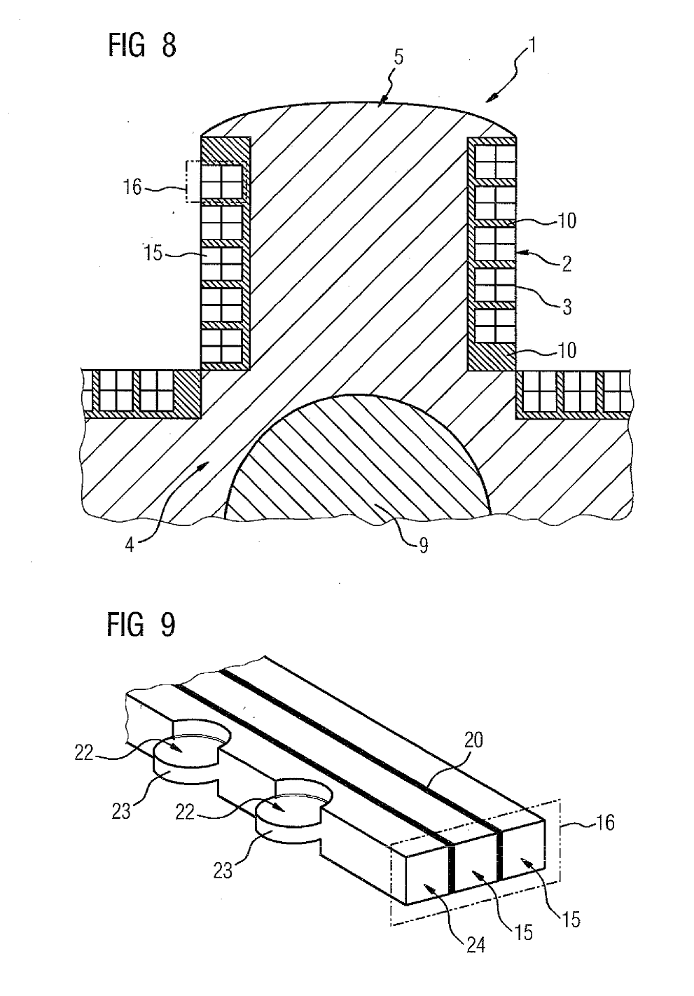

FIG. 8 a cross-section of part of a rotor of a synchronous machine with exciter coils with 2×2 sub-conductors,

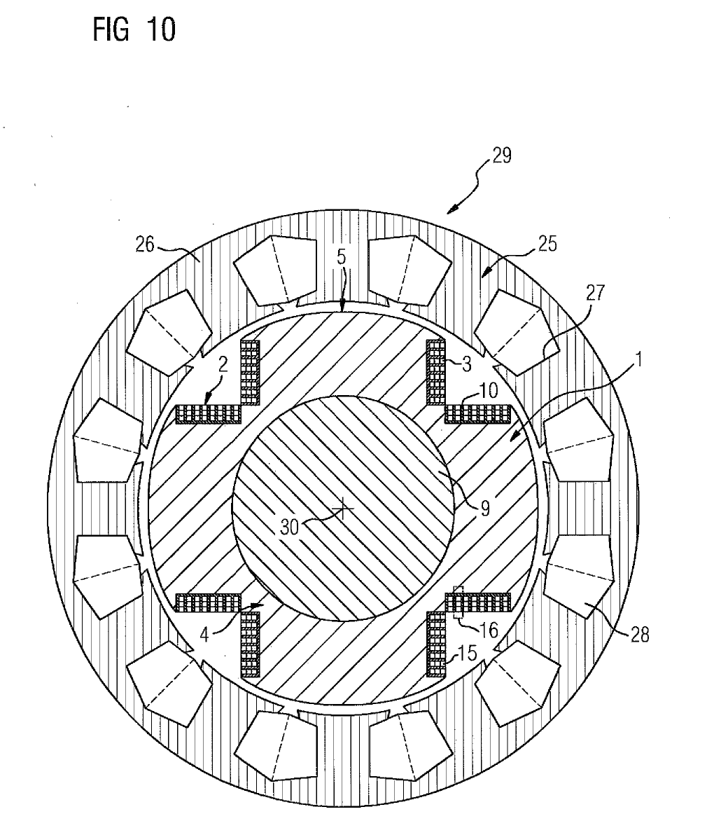

FIG. 9 a three-dimensional view of part of an exciter coil with 1×3 sub-conductors and cooling tabs, and

FIG. 10 a cross-section of a synchronous machine.

FIG. 1 shows a three-dimensional view of a rotor 1 of a synchronous machine 29 according to the prior art. Three-phase synchronous machines of this type can be described for instance as a motor or also as a generator. The synchronous machine 29 is embodied in particular as a high-rev drive with a rotational speed of more than 1000 r.p.m with a high output of more than one megawatt. High requirements in terms of electromagnetic and mechanical properties of the rotor 1 result from and as a result of the very strong centrifugal forces which emerge with such high rotational speeds. This involves a four-pole rotor 1 with external excitation for instance, wherein the four exciter coils 2 are arranged offset by 90°. The exciter coils 2 have windings 3 which are wound around a laminated core 4, which preferably consists of iron. Each exciter coil 2 is held in a radial direction by a pole shoe 5, which is fastened to the laminated core 4 with screws 6. Furthermore, the pole shoe 5 has the task of allowing the magnetic fields lines of the current-carrying exciter coil 2 to escape and be distributed in a defined form. Winding supports 7 additionally stabilize the exciter coils 2. A shaft 9 is connected to the laminated core 4 of the rotor 1 in a torsion-resistant manner. The laminated core 4 with the exciter coils 2 is cooled by a fan 8. In order to avoid notch stresses in the corners, the windings 3 of the exciter coils 2 are wound in an octagonal manner.

FIG. 2 shows a three-dimensional view of an exciter coil 2 according to the prior art. Two windings 3 of the exciter coil 2 are shown by way of example. The quadrangular exciter coil 2 consists of individual copper form profiles 12, for instance flat copper, which are cut from form profiles and then soldered together at the four corners 13 on the front side with a corner soldering 11 to form a continuous coil. The individual windings 3 of the exciter coil 2 are electrically insulated from one another by an insulation 10. The current is fed into the exciter coil 2 by way of supply lines 14. The production method of an exciter coil 2 as shown in FIG. 2 is very time-consuming and expensive. High notch stresses occur in the region of the corners 13.

FIG. 3 shows a cross-section of the rotor 1 of a synchronous machine 29. The four exciter coils 2 arranged orthogonally by way of example with respect to one another are held in a radial direction by a pole shoe 5 in each case, which is fastened to the laminated core 4 with screws 6. The shaft is connected in a torsion-resistant manner and preferably with a material fit to the laminated core 4 of the rotor 1. The individual windings 3 of the exciter coils 2 preferably consist of copper and are electrically insulated from one another and from the laminated core 4 by an insulation 10. Aside from the exciter coils 2, the pole shoes 5 with their approximately mushroom-shaped cross-section also contribute to distributing the magnetic field so that the rotor 1 generates as homogeneous a magnetic field as possible.

FIG. 4 shows a three-dimensional view of a continuous winding and soldering method according to the invention for an exciter coil 2 with 1×3 sub-conductors 15, wherein the sub-conductors 15 are located one on top of the other and have an identical preferably square cross-sectional surface. The parallel rectangular sub-conductors 15 can preferably be produced from standard semi-finished products, in particular from copper, and in the first step are joined together lengthwise loosely to form an entire conductor 16. By connecting a number of sub-conductors 15, which are embodied in one piece along their full length, to form an entire conductor 16, it is possible to manufacture different conductor geometries. After joining together the sub-conductors 15, the emerging loosely connected entire conductor 16 is wound with a winding spindle 17 to form an exciter coil 2 (see FIG. 6). The sub-conductors 15 of the entire conductor 16 are thereupon, directly after winding with a soldering device 18, soldered together with a rigid entire conductor 16 continuously to form a solid exciter coil 2. The soldering together of the parallel strings with a solder 20 is required in order to ensure a shear-resistant connection which provides the thus connected entire conductor 16 with the bending load capacity required for the emerging centrifugal force loads. Since these “inner” loads are not very high, a soft solder method is sufficient to minimize the cleaning work. During the continuous solder process, the sub-conductors 15 are held together in the desired position by the forming facilities 19. The manufacturing method shown in FIG. 4 can be applied both for salient-pole machines and also for non-salient pole machines.

FIG. 5 shows a three-dimensional view of a continuous winding and soldering method of an exciter coil 2 with 2×2 sub-conductors 15. The production method corresponds to the method shown in FIG. 4, wherein in FIG. 4, by way of example, four square sub-conductors 15 are processed with an identical cross-sectional surface to form a square entire conductor 16. Accordingly the sub-conductors 15 of two sides must be joined together lengthwise loosely to form an entire conductor 16. After joining together the sub-conductors 15, the emerging loosely connected square entire conductor 16 is wound with a winding spindle 17 to form an exciter coil 2 (see FIG. 6) and directly after the winding is continuously soldered together to form a solid exciter coil 2. During the continuous solder process, the 2×2 sub-conductors 15 are held together in the desired position by forming facilities 19 from two sides. The manufacturing method shown in FIG. 5 can be applied both for salient-pole machines and also for non-salient pole machines.

FIG. 6 shows a three-dimensional view of a part of an exciter coil 2 with 1×3 sub-conductors, which, by way of example, has two windings 3, wherein the entire conductor 16 was produced with the continuous winding and soldering method shown in FIG. 4. An insulation 10 is inserted between the two windings 3 shown, which has a high-voltage resistant electrically insulating plastic, in particular aramid, and which is suitable for insulating the two windings 3 against one another. The windings 3 of the exciter coil 2 have a favorably rounded radius shape 21 at the corners, as a result of which a notch stress in the corners is avoided. Supply and discharge lines at the ends of the exciter coil 2 can be integrated using the same process without the use of additional connecting parts.

FIG. 7 shows a three-dimensional view of part of an exciter coil 2 with 2×2 sub-conductors, which by way of example has two windings 3, wherein the square entire conductor 16 was produced with the continuous winding and soldering method shown in FIG. 5. Analogously to FIG. 6, an insulation 10 is inserted between the two windings 3 shown, which has a high-voltage resistant electrically insulating plastic, in particular aramid, and which is suitable for insulating the two windings 3 against one another. The windings 3 of the exciter coil 2 have a favorably rounded radius shape 21 at the corners, as a result of which a notch stress in the corners is avoided. Supply and discharge lines at the ends of the exciter coil 2 can be integrated using the same process without the use of additional connecting parts.

FIG. 8 shows a cross-section of a part of a rotor of a synchronous machine with exciter coils with 2×2 sub-conductors. By way of example this is a four-pole rotor 1 with external excitation, wherein the four exciter coils 2 only shown in part by way of example are arranged offset by 90°. By way of example, compared with FIG. 3, the four exemplary pole shoes 5 and the laminated core 4 of the rotor 1 are produced from one piece. The laminated core 4 in the axial direction with the pole shoes 5 which are produced from one piece can consist of a number of single sheets. The shaft is connected in a torsion-resistant manner and preferably with a material fit to the laminated core 4 of the rotor 1. The exciter coil is wound directly around the laminated core with the pole shoe. The exciter coils 2 are wound directly around the laminated core 4 with the integrated pole shoes 5. Accordingly, it is not necessary, as shown in FIG. 3, to mechanically fasten the pole shoe 5 to the laminated core 4 with screws 6 for instance. This results in an improved stability, particularly with high rotational speeds, since the screwed pole shoes 5 are exposed to high centrifugal forces particularly with high rotational speeds. The entire conductors 16 of the exciter coils 2 were produced with the continuous winding and soldering method shown in FIG. 4. The individual windings 3 of the exciter coils 2 preferably consist of copper and are electrically insulated from one another and from the laminated core 4 by an insulation 10. Aside from the exciter coils 2, the pole shoes 5 with their approximately mushroom-shaped cross-section also contribute to distributing the magnetic field so that the rotor 1 generates as homogeneous a magnetic field as possible.

FIG. 9 shows a three-dimensional view of part of an exciter coil 2 with 1×3 sub-conductors 15, 24 and cooling tabs 22, which are molded from one part of the outer sub-conductor 24. The cooling tabs 22 enlarge the surface of the outer sub-conductor 24 outwardly, which has an advantageous effect on the cooling of the current-carrying exciter coil 2. A lower temperature results in fewer losses in the exciter coil 2, since the specific resistance of copper increases with the temperature. The cooling tabs 22 are attached locally at regular intervals using suitable crimping tools. Functional areas, such as for instance winding supports 17, are saved here accordingly. Compared with the previous solution, in which the exciter coil was wound alternately with two copper conductors of different widths, a cooling winding and a normal winding, the effort involved in producing cooling tabs 22 on the outer sub-conductor 24 is significantly less and more cost-effective.

FIG. 10 shows a cross-section of a synchronous machine 29, which has a stator 25 and a rotor 1. The stator has a stator laminated core 26, in which slots 27 are disposed, in which the start windings 28 run. The rotor rotates around an axis of rotation 30. The design of the rotor 1 corresponds substantially to that in FIG. 8, wherein the entire conductors 16 of the exciter coils 2 are joined together from 1×3 sub-conductors 15 and are produced with the continuous winding and soldering method shown in FIG. 4.

In summary, the invention thus relates to a method for producing a rotor 1 for a synchronous machine 29, which is suitable for a rotational speed of more than 1000 r.p.m, having at least one exciter coil 2, wherein the at least one exciter coil 2 has at least two windings 3 in each case, which consist of a number of parallel electrically conductively connected rectangular sub-conductors 15. In order to produce the rotor cost-effectively and with high rotational speeds and the high centrifugal force loads associated therewith, it is proposed to produce the exciter coil 2 with a continuous winding and soldering method such that the number of parallel rectangular sub-conductors 15 are firstly joined together lengthwise loosely to form an entire conductor 16, whereupon the entire conductor 16 is wound to form an exciter coil 2 and directly after winding the sub-conductor 15 of the entire conductor 16 is soldered together continuously to form a solid exciter coil 2 with a rigid entire conductor 16.

What is claimed is:

1.-13. (canceled)

14. A method for producing a rotor for a synchronous machine suitable for a rotational speed of more than 1000 r.p.m, said method comprising:
loosely joining a plurality of electrically conductive rectangular sub-conductors in parallel to one another lengthwise to form a conductor;
winding the conductor so as to form a winding and thereby form an exciter coil; and
directly after the winding, continuously soldering together the sub-conductors of the conductor while the sub-conductors are positioned and/or held together by a forming facility, so that the exciter coil is solid and the conductor rigid.

15. The method of claim 14, wherein the loosely joined sub-conductors are wound by a winding spindle.

16. The method of claim 14, wherein the sub-conductors are soldered together by a soft solder process.

17. The method of claim 14, wherein the exciter coil includes two of said winding, and further comprising inserting an insulation between the two windings for insulating the two windings against one another, with the insulation having a high-voltage resistant electrically insulating plastic.

18. The method of claim 17, wherein the insulating plastic is aramid.

19. The method of claim 14, wherein the sub-conductors are produced from a standard semi-finished product.

20. The method of claim 14, wherein the standard semi-finished product are made of copper.

21. The method of claim 14, further comprising molding a cooling tab from a part of an outer one of the sub-conductors.

22. The method of claim 21, wherein the cooling tab is molded with a crimping tool.

23. The method of claim 14, further comprising positioning the wound and soldered exciter coil around a laminated core; and mechanically fastening step pole shoes to the laminated core.

24. A rotor for a synchronous machine suitable for a rotational speed of more than 1000 r.p.m, comprising an exciter coil which includes at least two windings, each said winding including a plurality of lengthwise electrically conductive and connected rectangular sub-conductors, each of said sub-conductors being embodied in one piece.

25. The rotor of claim 24, wherein the at least two windings of the exciter coil have rounded corners.

26. A synchronous machine suitable for a rotational speed of more than 1000 r.p.m, said synchronous machine comprising a rotor including an exciter coil, said exciter coil comprising at least two windings, each said winding including a plurality of lengthwise electrically conductive and connected rectangular sub-conductors, each of said sub-conductors being embodied in one piece.

27. The synchronous machine of claim 26, wherein the at least two windings of the exciter coil have rounded corners.
